(19) United States
(12) Patent Application Publication
(10) Pub. No.: US 2003/0150249 A1
(43) Pub. Date: Aug. 14, 2003

(54) Fertilizer soil treatment agent, soil treatment method, and soil-less medium

(76) Inventors: Gavin Patrick Gillman, Annandale (AU); Andrew Duncan Noble, Annandale (AU)

Correspondence Address: FOLEY AND LARDNER, SUITE 500, 3000 K STREET NW, WASHINGTON, DC, 20007, US

(21) Appl. No.: 10/182,335

(22) PCT Filed: Jan. 12, 2001
(86) PCT No.: PCT/AU01/00026

(30) Foreign Application Priority Data
Jan. 28, 2000 (AU) PQ 5337

(51) Int. Cl. C05D 1/00

(52) U.S. Cl. 71/31

(57) ABSTRACT

A fertilizer comprising at least one layered double hydroxide (LDH) compound containing at least one nutrient anion. In another aspect, the fertilizer comprising at least one clay material mixed with at least one nutrient cation. The fertilizer preferably comprises at least one layered double hydroxide (LDH) compound containing at least one nutrient anion and at least one clay material mixed with at least one nutrient cation. Methods for treating soil, for manufacturing the fertilizer and for enhancing plant growth are also described, as are soil conditioning agents and soil-less culture media.

The present invention relates to a method for treating soils. The present invention also relates to a soil conditioning agent, to a fertilizer and to a soil-less medium for growing plants.

### BACKGROUND TO THE INVENTION

Many soils in humid tropical regions have excellent physical properties. Moreover, such humid tropical regions typically have a weather pattern that includes a lengthy wet season during which significant rainfall occurs. Therefore, water is not a constraint to growing crops in such regions. However, such soils also typically have severe limitations with respect to their chemical nutrient status once they are cleared of virgin rainforest. The problems arise principally from a rapid decline in soil organic matter content. This leads to significant reductions in soil N and S because the bulk of these two nutrients is present in organic form. Moreover, rapid leaching of water-soluble nutrients, such as nitrates (NO₃⁻), phosphates (PO₄³⁻), potassium (K⁺), calcium (Ca²⁺) and magnesium (Mg²⁺) also occurs, which results in depletion of these elements from the soil while any remaining phosphate is tightly bound to the soil and thus unavailable for plant growth.

As a consequences, the six major plant nutrients, N, P, K, Ca, Mg and S, become limiting and must be regularly applied to the soil. Current fertilizer practices involve the use of soluble fertilizers and thus the soluble elements, such as Ca, Mg, K, nitrates, phosphates and sulphates, leach readily from the soil. Not only does this require frequent applications of fertilizers but the runoff can contaminate ground water and stream water.

Layered double hydroxides (hereinafter referred to as “LDH compounds”) are mixed hydroxides of divalent and tri-valent metals having an excess of positive charge that is balanced by interlayer anions. They can be represented by the general formula (1).

M₁₋ₓ²⁺Mₓ³⁺(OH)₂Aⁿ⁻yH₂O (1)

where M²⁺ and M³⁺ are di- and tri-valent metal ions respectively and Aⁿ⁻ is the interlayer anion of valence n. The x value represents the proportion of trivalent metal to the total amount of metal ion present and y denotes variable amounts of interlayer water.

Common forms of LDH comprise Mg²⁺ and Al³⁺ (known as hydrotalcites) and Mg²⁺ and Fe³⁺ (known as pyroaurites), but other cations including Ni, Zn, Mn, Ca, Cr, and La are known. The amount of surface positive charge generated is dependent upon the mole ratio of the metal ions in the lattice structure, and the conditions of preparation as they affect crystal formation. LDH compounds are well known in industry, being used as catalysts in organic conversion reactions, as PVC stabilizers, flame retardants, medicinal antacids, and in wastewater treatment. Their use as soil ameliorates and in fertilizer preparations had not been previously reported to the knowledge of the present inventors.

Clay materials are generally alumino-silicate materials having a net negative surface charge. Clays may be natural or synthetic materials. Natural clays are widespread and are found in the soil and in large deposits. An excess of clay material in soil is considered detrimental as the clay swells when it is wetted and thereafter presents a region of low water permeability. This can lead to heavy clay soils becoming waterlogged very easily. Much effort has been directed towards reducing or ameliorating the undue affects of clay in soil.

### SUMMARY OF THE INVENTIONS

The present inventors have now found that layered double hydroxides (LDH compounds) and/or clay materials can be used to beneficially treat soils.

In a first aspect, the present invention provides a method for treating soil comprising adding at least one LDH compound to the soil.

In one embodiment, the at least one LDH compound is added to the soil in an amount effective to increase the anion exchange capacity of the soil. This enhances the ability of the treated soil to retain nutrients, such as nitrates, sulphates and phosphates, in an exchangeable form. This results in those nutrients being less readily leachable from the soil.

In another embodiment, the at least one LDH compound is mixed with a least one nutrient anion prior to adding to the soil. In this embodiment the at least one LDH compound can act as a fertilizer. Preferably, the at least one LDH compound is loaded with the at least one nutrient anion, more preferably saturated with the at least one nutrient anion, prior to adding to the soil.

In a second aspect, the present invention provides a method for treating soil comprising adding a clay material to the soil.

In one embodiment, the clay material is added to the soil in an amount effective to increase the cation exchange capacity of the soil. This enhances the ability of the treated soil to retain nutrients, such as ammonium, potassium, calcium and magnesium, in an exchangeable form. This results in those nutrients being less readily leachable from the soil.

In another embodiment, the clay material is mixed with at least one nutrient cation prior to adding to the soil. In this embodiment, the clay material can act as a fertilizer. Preferably, the clay material is loaded with at least one nutrient cation, more preferably saturated with the at least one nutrient cation, prior to adding to the soil.

The clay material may be a natural clay or a synthetic clay. The preferred clay material for use in the present invention is bentonite, although it is believed that other clays may also be used. A mixture of two or more clays may be used.

In a particularly preferred embodiment of the invention, the at least one LDH compound and the clay material are added to the soil. This acts to increase the anion exchange capacity and cation exchange capacity of the soil. Even more preferably, the at least one LDH compound is mixed with at least one nutrient anion prior to mixing with the soil and the clay material is mixed with at least one nutrient cation prior to mixing with the soil.

In another aspect, the present invention provides a fertilizer comprising at least one LDH material mixed with at least one nutrient anion. Preferably, the fertilizer comprises at least one LDH material loaded with at least one nutrient anion, more preferably saturated with at least one nutrient anion.

In yet a further aspect, the present invention provides a fertilizer comprising a clay material mixed with at least one nutrient cation. Preferably, the fertilizer of this aspect of the invention comprises a clay material loaded with at least one nutrient cation, more preferably saturated with at least one nutrient cation.

In another aspect, the present invention provides a fertilizer comprising at least one LDH compound mixed with at least one nutrient anion and a clay material mixed with at least one nutrient cation.

Preferably, the at least one LDH compound is saturated with the at least one nutrient anion. Preferably, the clay material is saturated with the at least one nutrient cation.

The at least one LDH compound that is mixed with at least one nutrient anion and the clay material that is mixed with at least one nutrient cation may be blended together prior to adding to the soil.

The at least one nutrient anion may be selected from the group comprising nitrate, phosphate, sulphate and silicate. The at least one nutrient cation may be selected from the group comprising ammonium, potassium, calcium and magnesium. Other nutrients anions and cations may also be used.

The composition of the fertilizer of a preferred embodiment of the invention may be varied by varying the ratio of LDH compound to clay material. Further, any desired amount of individual nutrients, in any desired ratio (to other nutrients) could be produced. This allows the fertilizer to be specifically manufactured to be of particular benefit to a wide range of soil types or to be of particular benefit for specific crops.

Another aspect of the present invention also encompasses methods for producing the fertilizer described above.

For the fertilizer comprising at least one LDH compound mixed with at least one nutrient anion, the fertilizer may be produced by contacting the at least one LDH compound with a solution containing the at least one nutrient anion.

For the fertilizer comprising a clay material mixed with at least one nutrient cation, the clay material may be contacted with a solution containing the at least one nutrient cation.

The clay material used in the present invention is preferably a bentonite clay. Some natural bentonite deposits may contain saturating ions and thus it may also be possible to mix deposits from various locations to achieve a desired ratio of nutrient cations. This is especially applicable for bentonite that contains calcium and/or magnesium ions, whereas ammonium and potassium bentonite would most likely have to be artificially synthesized, for example, as outlined above.

In another embodiment, the at least one LDH compound may be mixed with a dry material containing the at least one nutrient anion. The mixture may then be added to the soil. Upon wetting of the soil, such as by rain or irrigation, the material containing the at least one nutrient anion will dissolve and the at least one LDH compound will act as a ‘sink’ for the at least one nutrient anion. Similarly, a clay material may be mixed with a dry material containing the at least one nutrient cation and the mixture added to the soil.

For example, one preferred embodiment may involve dry mixing bentonite or hydrotalcite with a material containing the cation or anion of interest, prior to addition to soil. For instance, gypsum or dolomite can be mixed with bentonite, and when moistened in the soil, the bentonite can act as a ‘sink’ for Ca (in the case of gypsum) or Ca and Mg (in the case of dolomite) when these materials slowly dissolve. Similarly. the mixing of superphosphate with hydrotalcite would cause the latter to adsorb phosphate.

The present invention also provides a soil conditioning agent comprising at least one LDH compound for adding to soil to thereby increase the anion exchange capacity of the soil. The present invention also provides a soil conditioning agent comprising a clay material for adding to soil to thereby increase the cation exchange capacity of the soil. Preferably, the soil conditioning agent comprises the clay material blended with the at least one LDH compound.

The fertilizer or soil conditioning agent of the present invention may be added to the soil in varying quantities, depending upon the particular requirements of the soil being treated. The person of skill in this art will readily be able to ascertain the amounts required to be added to the soil. For guidance, the present inventors have found that the addition of an LDH compound with an anion exchange capacity of 300 me/100 g would raise the anion exchange capacity of a 10 cm layer of soil by approximately 0.3 me/100 g of soil for each tonne/hectare increment of LDH compound added. Likewise, the addition of clay with a cation exchange capacity of 80 me/100 g would raise the cation exchange capacity of a 10 cm layer of soil by approximately 0.08 me/100 g for each tonne/hectare of clay added.

The fertilizer or soil conditioning agent of the present invention may be added to the soil by any suitable means.

The fertilizer or soil conditioning agent in accordance with the present invention may further include other additives to improve flowability and/or to prevent coherence. Extenders could also be added, if desired. Other agents typically added to fertilizers could also be added to the fertilizer or soil condition agent of the present invention. The at least one LDH compound and/or the clay material may also be added to an inert medium to provide a medium for soil-less culture.

In this aspect, the present invention provides a medium for soil-less culture comprising a substantially inert medium mixed with at least one LDH compound.

In one embodiment, the at least one LDH compound is added to the medium in an amount effective to increase the anion exchange capacity of the medium. This enhances the ability of the treated medium to retain nutrients, such as nitrates, sulphates and phosphates, in an exchangeable form. This results in those nutrients being less readily leachable from, or fixed by, the medium.

In another embodiment, the at least one LDH compound is mixed with at least one nutrient anion prior to adding to the medium. In this embodiment the at least one LDH compound can act as a fertilizer.

In another aspect, the present invention provides a medium for soil-less culture comprising a substantially inert medium mixed with a clay material.

In one embodiment, the clay material is added to the medium in an amount effective to increase the cation exchange capacity of the medium. This enhances the ability of the medium to retain nutrients, such as potassium, calcium and magnesium, in an exchangeable form.

In another embodiment, the clay material is mixed with at least one nutrient cation prior to adding to the medium. In this embodiment, the clay material can act as a fertilizer.

It is especially preferred that the medium for soil-less culture comprises a substantially inert medium mixed with at least one LDH compound and a clay material. The at least one LDH compound and the clay material may be treated with at least one nutrient anion and at least one nutrient cation, respectively as described above.

The at least one nutrient anion may be selected from the group comprising nitrate, phosphate, sulphate and silicate. The at least one nutrient cation may be selected from the group comprising ammonium, potassium, calcium and magnesium. Other nutrient anions and cations may also be used.

Apart from the six macro-elements previously mentioned, micro-elements and trace elements may be added in cationic or anionic form (eg Zn²⁺, Cu²⁺, SiO₄²⁻, BO₄³⁻) to fulfil all requirements for plant growth.

The substantially inert medium may comprise sand, glass beads, scoriaceous material or any other material that, by itself, has little or no capability for sustaining plant growth, but can provide suitable anchorage for root systems of plants.

The nutrients may be added in any desired amount up to the saturation level, or even beyond (in which case the nutrients may be effectively free nutrients in the interstitial space between particles). The amount of nutrient(s) added may also be tailored to specific uses, for example, to meet a particular nutrient requirement for a particular crop. The person of skill in the art will readily appreciate the amount of each particular nutrient that should or could be added. To provide guidance (and in no way suggesting that the following is limiting), the following amounts of nutrients may be needed to achieve saturation. Normally, larger amounts will be required to achieve saturation. In determining the following amounts, it was assumed that a typical bentonite has a Cation Exchange Capacity of 70 cmol(−) per kg and hydrotaclate has a typical Anion Exchange Capacity of 280 cmol(+) per kg:

| | |
|---|---|
| Ca | 14 kg Ca/tonne bentonite |
| Mg | 8.4 kg Mg/tonne bentonite |
| K | 27.3 kg K/tonne bentonite |
| NH₄ | 9.8 kg N/tonne bentonite |
| NO₃ | 39.2 kg P/tonne hydrotalcite |
| H₂PO₄/HPO₄ | 58 kg P/tonne hydrotalcite |
| SO₄ | 45 kg S/tonne hydrotalcite |

Additional P could be bound to the external surfaces of crystals of the LDH compound, perhaps as much as 50% as the interlayer P.

In a further aspect, the present invention provides a method for enhancing plant growth conditions comprising:

a) determining an optimum nutrient profile for growth of a plant in a soil,

b) preparing a fertilizer containing at least one LDH compound mixed with at least one nutrient anion and/or a clay material mixed with at least one nutrient cation, said fertilizer having the at least one nutrient anion and/or the at least one nutrient cation present in an amount such that said optimum nutrient profile is attained following addition of the fertilizer to the soil, and

c) adding the fertilizer to the soil.

Preferably, the method further comprises the steps of analyzing the nutrient profile of the soil, determining an optimum nutrient profile for the growth of a selected plant in the soil, determining a nutrient profile for the fertilizer that will result in the optimum nutrient profile for the growth of the selected plant in the soil being substantially attained in the soil when the fertilizer is added to the soil, manufacturing the fertilizer and adding the fertilizer to the soil.

The method may also include the steps of determining dosage rates for addition of the fertilizer to the soil and adding the determined dosage of fertilizer to the soil.

In one embodiment, the nutrient profile of the soil may reveal that the soil is deficient in one or more nutrient anions. In this embodiment, the step of manufacturing the fertilizer may comprise producing a fertilizer containing at least one LDH compound mixed with at least one nutrient anion.

In another embodiment, the nutrient profile of the soil may reveal that the soil is deficient in one or more nutrient cations. In this embodiment, the step of manufacturing the fertilizer may comprise producing a fertilizer containing a clay material with one or more nutrient cations mixed therewith.

In another embodiment, the nutrient profile of the soil may reveal that the soil is deficient in one or more nutrient anions and one or more nutrient cations. In this embodiment, the step of manufacturing the fertilizer may comprise producing a fertilizer containing at least one LDH compound mixed with at least one nutrient anion and a clay material with one or more nutrient cations mixed therewith.

It will be appreciated that the optimum nutrient profile for growth of a selected plant in that soil may not necessarily be the best possible nutrient profile for growth of that plant. In this regard, it will be appreciated that the soil composition may contain excess amounts of certain nutrients or even contain deleterious substances. In such cases, addition of the fertilizer may not overcome the deleterious nature of the excess nutrients or other substances. However, for that particular soil, addition of the fertilizer can achieve the optimum nutrient profile for growth of the selected plant in that soil.

In all aspects of the present invention that include at least one LDH compound, the preferred at least one LDH compound is hydrotalcite. It is especially preferred that the hydrotalcite be in the chloride form, in which chloride is the interlayer anion. It has been found that the chloride ion is not firmly held in the hydrotalcite, thereby rendering it relatively simple to exchange the chloride ion for the nutrient anion(s). Other forms of hydrotalcite that may be used in the present invention include those containing sulphate or phosphate, as these ions may also be exchanged.

The most commonly manufactured LDH is carbonate-LDH. The carbonate ion is very specifically held in LDH, and is difficult to displace with other anions. These are held with varying degree of specificity. eg. CO₃>PO₄>SO₄>Cl=NO₃

A Cl-LDH is therefore preferred, since it can be saturated with any anion, by soaking in the appropriate solution. Thus a Cl-LDH is readily converted to a NO₃-LDH by treatment with e.g. a KNO₃ solution.

In one of our preferred ways of preparing technical-grade LDH, concentrated seawater (bitterns) is used as the Mg source. Though predominantly present with Cl, there is also some SO₄ in bitterns, resulting in the formation of a Cl/SO₄-LDH. The latter can be converted to a PO₄-LDH, a PO₄/SO₄-LDH, a NO₃/SO₄-LDH etc, by choosing appropriate solutions for soaking.

These various LDH's can be blended to produce LDH product in desired ratios of N:P:S.

### DETAILED DESCRIPTION OF THE INVENTION

A preferred embodiment of the present invention will now be described with reference to the following Examples.

### EXAMPLES

Several hydrotalcite-like compounds were synthesized in preliminary experiments, using different methods of preparation, different Al:Mg ratios, and different overall molarities. Results are summarized in Table 1. Column four of Table 1 indicates anion exchange capacity (AEC) values for the hydrotalcites as determined by the amount of chloride ion that could be adsorbed in exchangeable form. These chloride-saturated products were then treated with nitrate solution to determine whether interlayer chloride could be replaced by nitrate. The results in column 5 show that the hydrotalcites are easily converted from chloride form to nitrate form.

TABLE 1
AEC values recorded on a series of hydrotalcite-like materials prepared
under varying conditions.

| | Combined | | AEC (me/100 g) | | |
|---|---|---|---|---|---|
| Sample | Molarity | Al/Al + Mg | Cl ads. | NO₃ ads | % Conversion |
| HT1 | 0.50 | 0.25 | 134 | n.d. | — |
| HT2 | 0.50 | 0.50 | 140 | 142 | 101 |
| HT3 | 0.45 | 0.18 | 160 | 107 | 67 |
| HT4 | 0.44 | 0.14 | 127 | 100 | 79 |
| HT5 | 2.18 | 0.31 | 320 | 293 | 92 |
| HT6 | 2.00 | 0.25 | 242 | 220 | 91 |

In a further experiment, the chloride-saturated form of HT5 and HT6 were treated with phosphate solution, and again, phosphate completely replaced chloride up to the limit of the hydrotalcite anion exchange capacities.

A pyroaurite was prepared using Fe:Mg ratio, overall molarity, and preparation conditions identical to those pertaining for the synthesis of HT5. This pyroaurite (PA1) has a measured anion exchange capacity of 150 me/100 g.

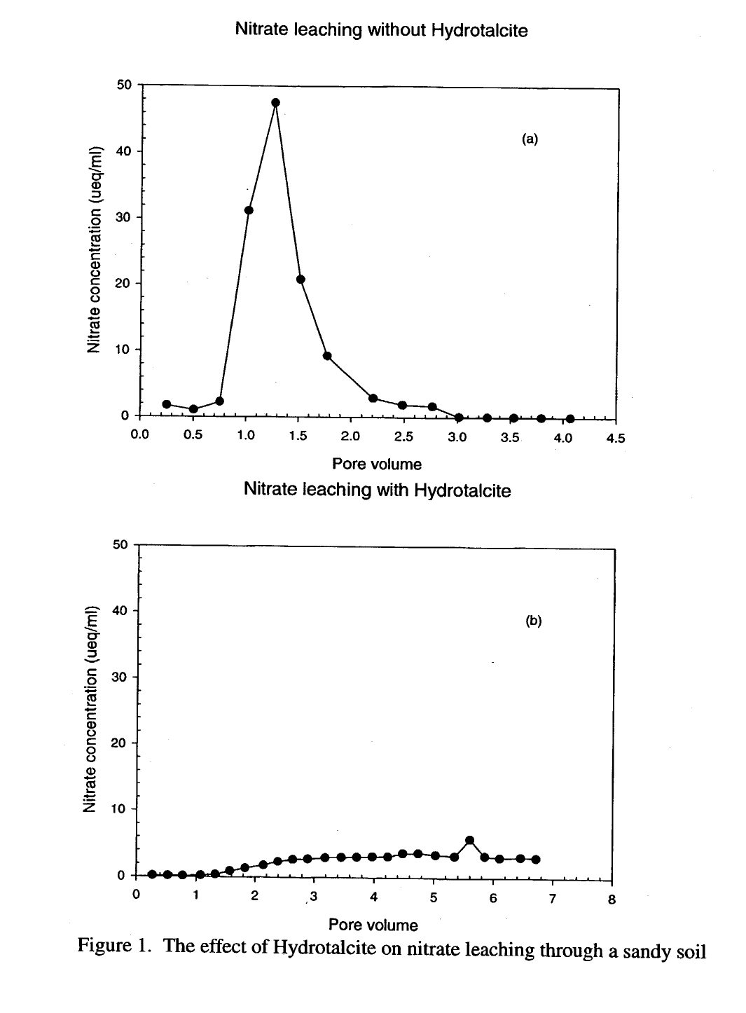

The effectiveness of hydrotalcite addition in increasing soil anion exchange capacity, and therefore the ability of the soil to retain nitrate was studied by adding HT5 at the rate of 30 t/ha to a sandy soil in a leaching column, placing a ‘slug’ of nitrate on top of the soil column to which no hydrotalcite had been added. The results, summarized in FIG. 1 show that nitrate moved rapidly through the unamended soil (FIG. 1a), whereas the soil containing hydrotalcite (FIG. 1b), nitrate leaching was severely retarded.

The fertilizer component of the currently most preferred embodiment of the present invention relates to the production of LDH compounds saturated with a range of nutrients anions obtained from any suitable source (nitrate, sulfate, phosphate, silicate), and blending them with bentonite clay that has been saturated with a range of nutrient cations. A desired amount of individual nutrients, in any desired ratios could be produced via simple mixing of the individually saturated compounds.

### Example 2

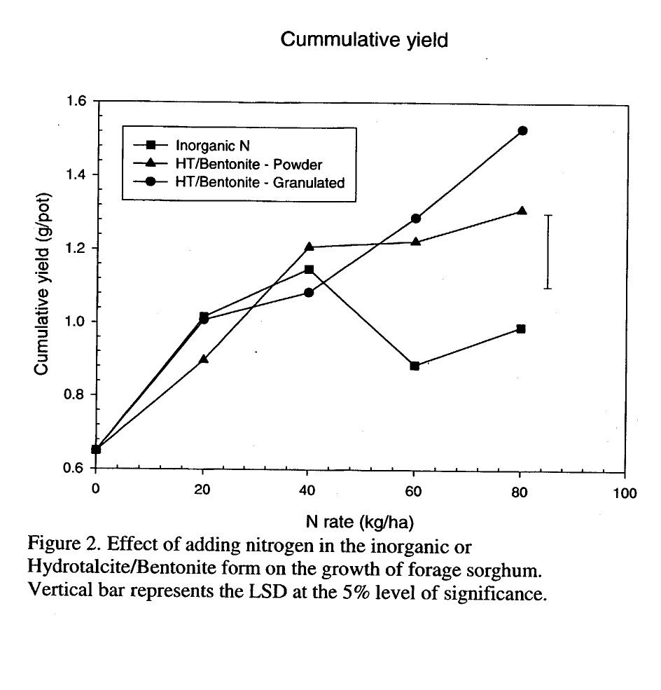

In order to demonstrate the advantageous effects of the fertilizer or soil conditioning agent of the present invention, plant growth trials were conducted. In these trials, a very sandy soil was mixed with ammonium-saturated bentonite and nitrate-saturated hydrotalcite. The bentonite/hydrotalcite mixtures were applied as powder and as granules. FIG. 2 shows the cumulative dry weight of application to the soil and the cumulative yield (g/pot) of plants grown under otherwise identical conditions. A control using an inorganic nitrogen fertilizer was provided for comparative purposes.

As can be seen from FIG. 2, treating the soil with fertilizer or soil conditioning agents in accordance with the present invention promotes plant growth.

### Example 3

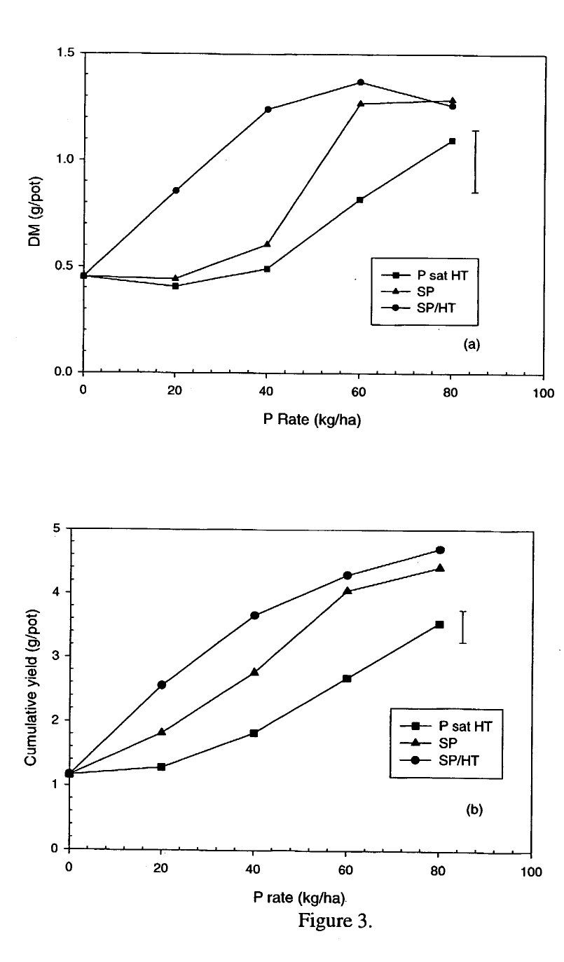

In another trial, a clay soil known to fix phosphate strongly was treated with hydrotalcite that had been saturated with P, and also with a chloride-saturated hydrotalcite that had been simply mixed with superphosphate. A control using superphosphate only was provided for comparative purposes. FIG. 3 (top graph) shows the dry weight yield of forage sorghum at the fourth harvest, while FIG. 3 (bottom graph) shows cumulative yield over four harvests. It is clear that P-saturated hydrotalcite promotes plant growth, though not as strongly as conventional superphosphate at equivalent

rates of P application, whereas the mixture of Cl-satutrated P and superphosphate was superior to superphosphate, especially at the low rate of P applied. However, it is expected that the fertilizers in accordance with the present invention would outperform superphosphate over an extended period of time.

### Example 4

### Beneficiated Bentonite

A preferred ratio of nutrient cations on bentonite might be Ca:Mg:K=4:2:1 in terms of charge equivalents. This could be achieved in several ways: e.g. blending bentonites that have been separately saturated with Ca, Mg, and K. The mixture would contain about 57% (4/7) Ca-bentonite, about 28.5% Mg-bentonite, and about 14.5% K-bentonite, and this would be achieved by mixing 570 kg of Ca-bentonite, 285 kg of Mg-bentonite, and 145 kg of K-bentonite, to produce 1 tonne of product in the desired equivalent ratio of 4:2:1.

In another example, it would be possible to blend naturally occurring bentonites with beneficiated bentonite to achieve the desired ratio. Thus if a 100% Ca-bentonite deposit was identified, and also a 50% Ca/50% Mg-bentonite deposit, these could be mixed with a K-bentonite (perhaps obtained by saturating Na-bentonite with KCl) in the following proportions:

140 kg Ca-bentonite

700 kg Ca/Mg bentonite

160 kg K-bentonite

to produce 1 tonne of product in the desired equivalent ratio of 4:2:1.

The present invention provides fertilizer or soil conditioning agents that may be used to improve any soil-type in need of such improvements. The present invention allows the possibility of providing fertilizers loaded with nutrients in ranges that can be specifically tailored for treatment of a particular soil type or for use in growing crops having specific nutrient requirements. For example, if a soil is badly deficient in phosphorus and slightly deficient in nitrogen, the fertilizer or soil conditioning agent of the present invention may be treated to have a high phosphorus content and a relatively low nitrogen content. Moreover, the fertilizers and soil conditioning agents of the present invention are also effectively slow release. They are easier and cheaper to produce than conventional slow release fertilizers, which typically require the formation of a physical barrier around granules of the fertilizer.

The present invention also assists in improving the effects of addition of conventional fertilizers due to the ability of the materials of the present invention to retain nutrients and thereby reduce or slow down the loss of the nutrients from the soil.

Those skilled in the art will appreciate that the invention described herein may be subject to variations and modifications other than those specifically described. It will be understood that the present invention encompasses all such variations and modifications that fall within its spirit and scope.

1. A fertilizer comprising a combination of
(a) at least on layered double hydroxide (LDH) compound containing at least one nutrient anion; and
(b) at least one clay material mixed with at least one nutrient cation.

2. A fertilizer as claimed in claim 1 wherein the at least one LDH compound is loaded with the at least one nutrient anion.

3. A fertilizer as claimed in claim 1 wherein the at least one LDH compound is saturated with the at least one nutrient anion.

4. A fertilizer as claimed in any one of claims 1 to 3 wherein the at least one LDH compound is hydrotalcite or pyroaurite.

5. A fertilizer as claimed in any one of claims 1 to 4 wherein the at least one nutrient anion is selected from a nitrogen-containing anion, a phosphorus-containing anion, a sulphur-containing anion, a silicate anion or a boron-containing anion, and mixtures thereof.

6. A fertilizer as claimed in claim 1 wherein the clay material is loaded with the at least one nutrient cation.

7. A fertilizer as claimed in claim 1 wherein the clay material is saturated with the at least one nutrient cation.

8. A fertilizer as claimed in any one of claims 1 to 7 wherein the at least one nutrient cation is selected from the group comprising calcium cations, potassium cations, magnesium cations, zinc cations, copper cations ammonium cations and mixtures of two or more thereof.

9. A fertilizer as claimed in any one of claims 1 to 8 wherein the clay material is bentonite.

10. A medium for soil-less culture comprising a substantially inert medium mixed with at least one LDH compound and at least one clay material.

11. A medium as claimed in claim 10 wherein the at least one LDH compound is added in an amount effective to increase the anion exchange capacity of the medium.

12. A medium as claimed in claim 10 or claim 11 wherein the at least one LDH compound is mixed with at least one nutrient anion.

13. A medium as claimed in any one of claims 10 to 12 wherein the clay material is added in an amount effective to increase the cation exchange capacity of the medium.

14. A medium as claimed in any one of claims 10 to 13 wherein the clay material is mixed with at least one nutrient cation.

15. A method for producing a fertilizer as claimed in any one of claims 1 to 9 comprising the step of contacting the at least one LDH compound with a material containing the at least one nutrient anion, contacting the clay material with a material containing the at least one nutrient cation and mixing the thus treated at least one LDH compound and clay material together.

16. A method as claimed in claim 15 wherein the clay material is further mixed with a natural clay material containing one or more nutrient cations.

17. A method as claimed in claim 15 or claim 16 comprising the step of mixing the at least one LDH compound with a dry material containing the at least one nutrient anion.

18. A method as claimed in any one of claims 15 to 17 comprising the step of mixing the clay material with a dry material containing the at least one nutrient cation.

19. A method as claimed in claim 17 or claim 18 wherein the dry material comprises a conventional fertilizer.

20. A method as claimed in claims 15 or 16 wherein a solution containing the at least one nutrient anion is mixed with at least one LDH compound.

21. A method as claimed in claims 15 or 16 wherein a solution containing the at least one nutrient cation is mixed with the clay material.

22. A method for enhancing plant growth conditions comprising:
a) determining an optimum nutrient profile for growth of a plant in a soil,
b) preparing a fertilizer containing at least one LDH compound mixed with at least one nutrient anion and/or a clay material mixed with at least one nutrient cation, said fertilizer having the at least one nutrient anion and/or the at least one nutrient cation present in an amount such that said optimum nutrient profile is attained following addition of the fertilizer to the soil, and
c) adding the fertilizer to the soil.

23. A method as claimed in claim 22 further comprising the steps of analyzing the nutrient profile of the soil, determining an optimum nutrient profile for the growth of a selected plant in the soil, determining a nutrient profile for the fertilizer that will result in the optimum nutrient profile for the growth of the selected plant in the soil being substantially attained in the soil when the fertilizer is added to the soil, manufacturing the fertilizer and adding the fertilizer to the soil.

24. A method as claimed in claim 22 or 23 further comprising the steps of determining dosage rates for addition of the fertilizer to the soil and adding the determined dosage of fertilizer to the soil.

25. A method as claimed in any one of claims 22 to 24 wherein analysis of the nutrient profile of the soil reveals that the soil is deficient in one or more nutrient anions and the step of manufacturing the fertilizer comprises producing a fertilizer containing at least one LDH compound mixed with at least one nutrient anion.

26. A method as claimed in any one of claims 22 to 25 wherein analysis of the nutrient profile of the soil reveals that the soil is deficient in one or more nutrient cations and the step of manufacturing the fertilizer comprises producing a fertilizer containing a clay material with one or more nutrient cations mixed therewith.

27. A method as claimed in any one of claims 22 to 25 wherein analysis of the nutrient profile of the soil reveals that the soil is deficient in one or more nutrient anions and one or more nutrient cations and the step of manufacturing the fertilizer comprises producing a fertilizer containing at least one LDH compound mixed with at least one nutrient anion and a clay material with one or more nutrient cations mixed therewith.

28. A method for producing a fertilizer as claimed in any one of claims 15 to 19 wherein the at least one LDH compound has chloride ions as interlayer anions prior to contact with the at least one nutrient anion.

29. A method for enhancing plant growth as claimed in any one of claims 22 to 27 wherein the at least one LDH compound has chloride ions as interlayer anions prior to contact with the at least one nutrient anion.
